(19) United States
(12) Patent Application Publication
(10) Pub. No.: US 2012/0289271 A1
(43) Pub. Date: Nov. 15, 2012

(54) DATA DISTRIBUTION SYSTEM, SERVER, BASE STATION, AND METHOD

(75) Inventor: Takao Nakagawa, Kawasaki (JP)

(73) Assignee: FUJITSU LIMITED, Kawasaki-shi (JP)

(21) Appl. No.: 13/428,080

(22) Filed: Mar. 23, 2012

(30) Foreign Application Priority Data
Apr. 28, 2011 (JP) 2011-102042

(51) Int. Cl. H04W 4/06; H04W 72/00

(52) U.S. Cl. 455/509; 455/517

(57) ABSTRACT

A data distribution system includes a mobile station, a base station, and a server that distributes data to the mobile station via the base station. The base station transmits information about a line condition between the base station and the mobile station to the server. The server distributes data to the base station based on the information about the line condition.

### CROSS-REFERENCE TO RELATED APPLICATION(S)

This application is based upon and claims the benefit of priority of the prior Japanese Patent Application No. 2011-102042, filed on Apr. 28, 2011, the entire contents of which are incorporated herein by reference.

### FIELD

The embodiments discussed herein are related to a technology for distributing data from a server in response to a request from a mobile station.

### BACKGROUND

A content server (hereinafter, referred to as a server) distributes data such as web content to mobile stations in response to requests from the mobile stations. The server transmits data, including content requested by the mobile stations, to base stations that are connected to the server by a wired network. The base stations transmit by radio the data received from the server. The mobile stations receive the data transmitted by radio from the base stations. As the frequency with which the mobile stations request content updates increases, the number of data distributions from the server to the mobile stations per certain time also increases. The content herein includes a set of information that is viewed by a user, such as, video, images, audio, text, or a combination thereof.

When a line busy rate between a mobile station and a base station becomes high, continuation of a data distribution service from a server to the mobile station may be impossible. Japanese Laid-open Patent Publication No. 2004-133502, Japanese Laid-open Patent Publication No. 2002-41823, Japanese Laid-open Patent Publication No. 2002-118332, and Japanese Laid-open Patent Publication No. 2006-236284, disclose technologies in which content data is automatically transmitted from a server to a buffer in a mobile station in response to a request registered in advance, in order to continue the service even when the line busy rate becomes high.

When a server regularly transmits data, the server continues to transmit data to base stations regardless of line conditions between the base stations and mobile stations. The server and the base stations are connected by a wired network, whereas the base stations and the mobile stations are connected by radio communication. The communication environment of radio communication changes with time, and radio communication is further influenced by environmental noise. Accordingly, radio communication is likely to have a higher line busy rate due to a decrease in data rate or insufficient communication resources.

Since a server continues to transmit data even when a line busy rate between a base station and a mobile station is high, data of large size may cause a scarcity of communication resources during the transmission of the data from the base station to the mobile station. Since data that fails to be transmitted is transmitted again, a failure of transmission of data results in increases in the amount of traffic between a server and a base station, and in the processing load for the base station.

### SUMMARY

According to an aspect of the invention, a data distribution system includes a mobile station, a base station, and a server that distributes data to the mobile station via the base station. The base station transmits information about a line condition between the base station and the mobile station to the server. The server distributes data to the base station based on the information about the line condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a data distribution system;

FIG. 2 is a functional block diagram of a mobile station;

FIG. 3 is a hardware block diagram of a mobile station;

FIG. 4 is a functional block diagram of a base station;

FIG. 5 is a hardware block diagram of a base station;

FIG. 6 is a functional block diagram of a server;

FIG. 7 is a hardware block diagram of a server;

FIGS. 8A to 8C are tables illustrating weighting coefficients used for computing a priority for content;

FIG. 9 is a block diagram illustrating how pieces of content are linked to each other and priorities for the pieces of the content;

FIG. 10 is a flowchart of a priority computation process performed by a priority computation unit;

FIGS. 11A and 11B are image diagrams illustrating line-condition information transmitted from a base station to a server;

FIG. 12 is a sequence diagram illustrating the overall process of a data distribution system;

FIGS. 13A and 13B are flowcharts of processes performed by a server;

FIG. 14 is a flowchart of a line-condition computation process performed by a base station; and

FIG. 15 is a flowchart of a content-data viewing process performed by a mobile station.

### DESCRIPTION OF EMBODIMENTS

Hereinafter, embodiments will be described. Note that combinations of configurations according to the embodiments are also included in the embodiments discussed herein.

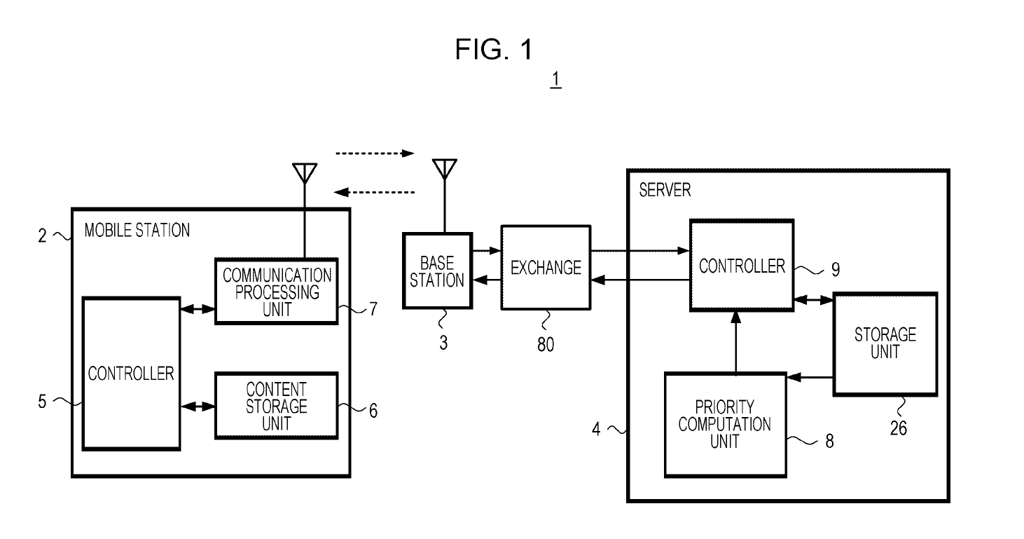

FIG. 1 is a block diagram illustrating a data distribution system 1 according to an embodiment discussed herein. The data distribution system 1 includes a mobile station 2, a base station 3, an exchange 80, and a server 4. The data distribution system 1 is a system that distributes content requested by the mobile station 2 from content accumulated in the server 4. The mobile station 2 includes a controller 5, a content storage unit 6, and a communication processing unit 7. The server 4 includes a controller 9, a priority computation unit 8, and a storage unit 26.

The controller 5 transmits to the communication processing unit 7 a control signal to cause the communication processing unit 7 to transmit to the server 4 a distribution request signal that requests a content distribution. The controller 5 also processes the content that is distributed from the server 4 and is stored in the content storage unit 6.

The communication processing unit 7 transmits to the server 4 a distribution request signal for content in accordance with the control signal received from the controller 5, and also processes the content received from the server 4. The content storage unit 6 stores the content received and processed by the communication processing unit 7.

The base station 3 transmits to the server 4 the distribution request signal for content received from the mobile station 2. The base station 3 also transmits content received from the server 4 to the mobile station 2. The base station 3 forms a cell indicating an area in which the base station 3 is capable of communicating with mobile stations. Typically, multiple mobile stations other than the mobile station 2 are present in the cell area for the base station 3.

The exchange 80 is in charge of a communication path between the base station 3 and the mobile station 2. According to the embodiment, to simplify the configuration to be described, description will be made using a configuration in which the exchange 80 is connected to one base station and in which one base station communicates with one mobile station. The exchange 80 is capable of communicating with multiple base stations (not illustrated). Each of the multiple base stations is capable of communicating with multiple mobile stations. The exchange 80 manages communication path information indicating through which base station the communication is made with each of the mobile stations. The exchange 80 transmits the communication path information to the server 4.

The controller 9 processes the distribution request signal received from the mobile station 2 via the base station 3. The controller 9 reads out content from the storage unit 26 based on the result of the processing of the distribution request signal and a computation result from the priority computation unit 8, and transmits the content to the base station 3.

The storage unit 26 stores the result of the processing performed by the controller 9 of the distribution request signal from the mobile station 2, and the content to be transmitted to the mobile station 2. The priority computation unit 8 computes a priority for the content to be transmitted to the mobile station 2, based on the result, which is stored in the storage unit 26, of the processing of the distribution request signal. The priority computation unit 8 transmits the computation result for priority to the controller 9.

As described above, the server 4 is capable of distributing content to the mobile station 2 in accordance with a distribution request signal received from the mobile station 2. The server 4 is also capable of determining a distribution order in which content is distributed to the mobile station 2, in accordance with the computation result obtained by the priority computation unit 8.

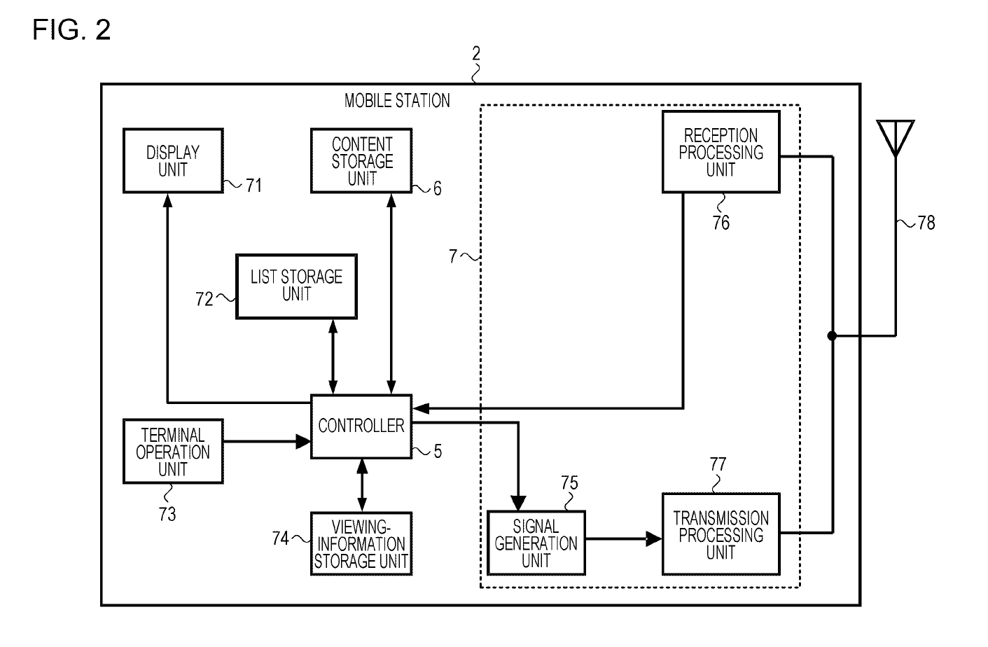

FIG. 2 is a functional block diagram of the mobile station 2. The mobile station 2 includes a display unit 71, a terminal operation unit 73, the content storage unit 6, a list storage unit 72, the controller 5, a viewing-information storage unit 74, the communication processing unit 7, and an antenna 78. The communication processing unit 7 further includes a signal generation unit 75, a reception processing unit 76, and a transmission processing unit 77.

The display unit 71 functions as an output device for displaying content to be viewed. The terminal operation unit 73 functions as an input device for specifying content so as to instruct the controller 5 to request the server 4 to distribute the content. The terminal operation unit 73 also functions as an input device for selecting content which a user wants to display and view on the display unit 71. The controller 5 reads out content data from the content storage unit 6 in accordance with the information that is input from the terminal operation unit 73, and displays the content that is read out on the display unit 71.

The content storage unit 6 stores the content data received from the server 4. The list storage unit 72 stores a list of the content data stored in the content storage unit 6. The controller 5 analyzes the content data stored in the content storage unit 6 to obtain the list of the content data, and writes the list in the list storage unit 72. The controller 5 displays the content data stored in the content storage unit 6 on the display unit 71, in accordance with the list stored in the list storage unit 72.

The controller 5 transmits a generation signal, for generating a distribution request signal to be transmitted to the server 4, to the signal generation unit 75 in accordance with the input from the terminal operation unit 73. The controller 5 also transmits viewing information indicating which content has been selected to the viewing-information storage unit 74 in accordance with the input from the terminal operation unit 73. The viewing-information storage unit 74 stores the received viewing information.

According to the embodiment, the content storage unit 6, the list storage unit 72, and the viewing-information storage unit 74 are described as separate storage units. However, each of these storage units may be stored in a different storage area in the same storage unit.

The controller 5 transmits a generation signal for generating viewing information, which is to be transmitted to the server 4, to the signal generation unit 75 in accordance with the viewing information stored in the viewing-information storage unit 74. The controller 5 transmits the generation signal to the signal generation unit 75 at certain periodic intervals. The signal generation unit 75 generates the viewing information to be transmitted to the server 4 in accordance with the generation signal.

The transmission processing unit 77 generates modulated signals for transmitting the distribution request signal and the viewing information to the base station 3. When the transmission processing unit 77 fails to transmit the viewing information, the controller 5 again transmits a generation signal to the signal generation unit 75 based on the viewing information that is read out from the viewing-information storage unit 74. The transmission processing unit 77 modulates the viewing information and outputs the modulated information to the antenna 78. The antenna 78 transmits by radio the modulated signals received from the transmission processing unit 77, and also receives radio signals transmitted from the base station 3 and outputs the received signals to the reception processing unit 76.

The reception processing unit 76 demodulates content data transmitted from the server 4 via the base station 3 to convert the content data into a digital signal. The content storage unit 6 stores the content data that was converted into a digital signal.

As described above, the mobile station 2 is capable of transmitting a distribution request signal to the server 4, and is also capable of storing content data received from the server 4.

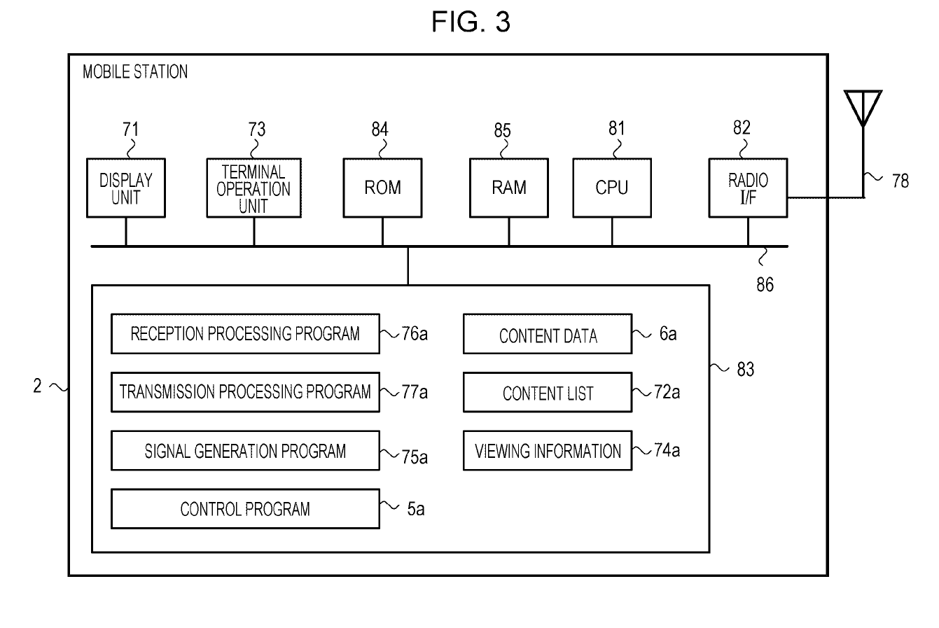

FIG. 3 is a hardware block diagram of the mobile station 2. The mobile station 2 includes the display unit 71, the terminal operation unit 73, a read only memory (ROM) 84, a random access memory (RAM) 85, a central processing unit (CPU) 81, a radio interface (radio I/F) 82, a storage unit 83, and the antenna 78. In FIG. 3, the same members as those in the functional block diagram of the mobile station 2 in FIG. 2 are designated with the same reference numerals, and are not described.

The CPU 81 is a computation unit that functions as each functional block illustrated in FIG. 2 by executing a program stored in the storage unit 83. The CPU 81 functions as the reception processing unit 76 by executing a reception processing program 76a stored in the storage unit 83. The CPU 81 functions as the transmission processing unit 77 by executing a transmission processing program 77a stored in the storage unit 83. The CPU 81 functions as the signal generation unit 75 by executing a signal generation program 75a stored in the storage unit 83. The CPU 81 functions as the controller 5 by executing a control program 5a stored in the storage unit 83.

The storage unit 83 includes the reception processing program 76a, the transmission processing program 77a, the signal generation program 75a, the control program 5a, a content data 6a, a content list 72a, and a viewing information 74a. The storage unit 83 functions as the content storage unit 6 storing the content data 6a, the list storage unit 72 storing the content list 72a, and the viewing-information storage unit 74 storing the viewing information 74a.

The ROM 84 is nonvolatile memory such as flash memory. The RAM 85 is volatile memory such as dynamic random access memory (DRAM). An internal bus 86 is used for data transmission between the devices installed in the mobile station 2. The radio I/F 82 is implemented by, for example, an analog circuit or a digital signal processor (DSP), and functions as the reception processing unit 76 and the transmission processing unit 77. The radio I/F 82 converts radio signals into bus signals and vice versa.

The hardware configuration described above allows the mobile station 2 to implement the functional blocks illustrated in FIG. 2.

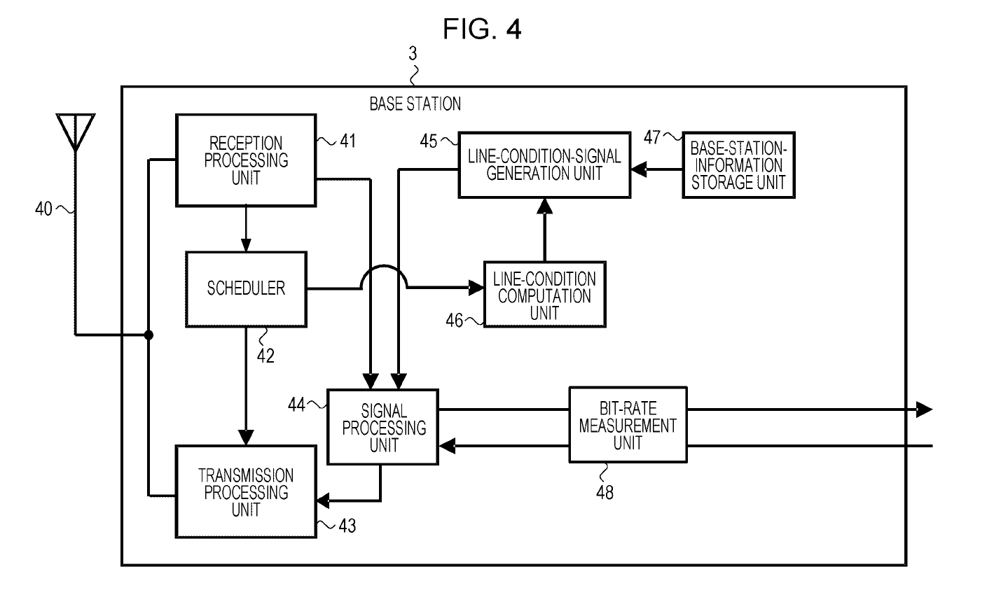

FIG. 4 is a functional block diagram of the base station 3. The base station 3 includes an antenna 40, a reception processing unit 41, a scheduler 42, a transmission processing unit 43, a signal processing unit 44, a line-condition-signal generation unit 45, a line-condition computation unit 46, a base-station-information storage unit 47, and a bit-rate measurement unit 48.

The antenna 40 receives radio signals transmitted from the mobile station 2, and also transmits signals received from the transmission processing unit 43, in the form of radio signals.

The reception processing unit 41 demodulates signals received from the antenna 40. The reception processing unit 41 transmits the demodulated signals to the signal processing unit 44. The reception processing unit 41 also notifies the scheduler 42 of reception schedule information, such as the reception timing and the data amount of a signal.

The scheduler 42 transmits transmission schedule information for controlling the transmission timing of a transmission signal, the frequency band to be used, and the like, to the transmission processing unit 43 based on the reception schedule information received from the reception processing unit 41. The scheduler 42 also transmits communication schedule information to the line-condition computation unit 46 based on the reception schedule information received from the reception processing unit 41 and the transmission schedule information transmitted to the transmission processing unit 43.

The line-condition computation unit 46 computes a line condition based on the communication schedule information received from the scheduler 42. The line-condition computation unit 46 transmits to the line-condition-signal generation unit 45 a generation signal based on the line condition, which is the computation result. The line condition between the base station 3 and the mobile station 2 includes a case in which the mobile station 2 is incapable of communicating with the base station 3.

The base-station-information storage unit 47 stores the identification information of the base station 3. The line-condition-signal generation unit 45 reads out the identification information of the base station 3 from the base-station-information storage unit 47. The line-condition-signal generation unit 45 generates a line-condition signal in which the line-condition information received from the line-condition computation unit 46 and the identification information are combined.

The transmission processing unit 43 determines the transmission timing, the frequency band to be used, and the like for a transmission signal received from the signal processing unit 44, in accordance with the transmission schedule information received from the scheduler 42, and transmits the transmission signal.

The signal processing unit 44 converts received signals received from the reception processing unit 41 into IP packets, and transmits the IP packets to the bit-rate measurement unit 48. The signal processing unit 44 transmits the line-condition information received from the line-condition-signal generation unit 45 to the server 4 via the bit-rate measurement unit 48. The signal processing unit 44 also transmits signals received from the server 4 via the bit-rate measurement unit 48 to the transmission processing unit 43.

The bit-rate measurement unit 48 measures the bit rate of a signal received from the signal processing unit 44. The bit-rate measurement unit 48 is capable of transmitting the measurement result to the server 4 as line-condition information.

As described above, the base station 3 is capable of transmitting the line-condition information to the server 4.

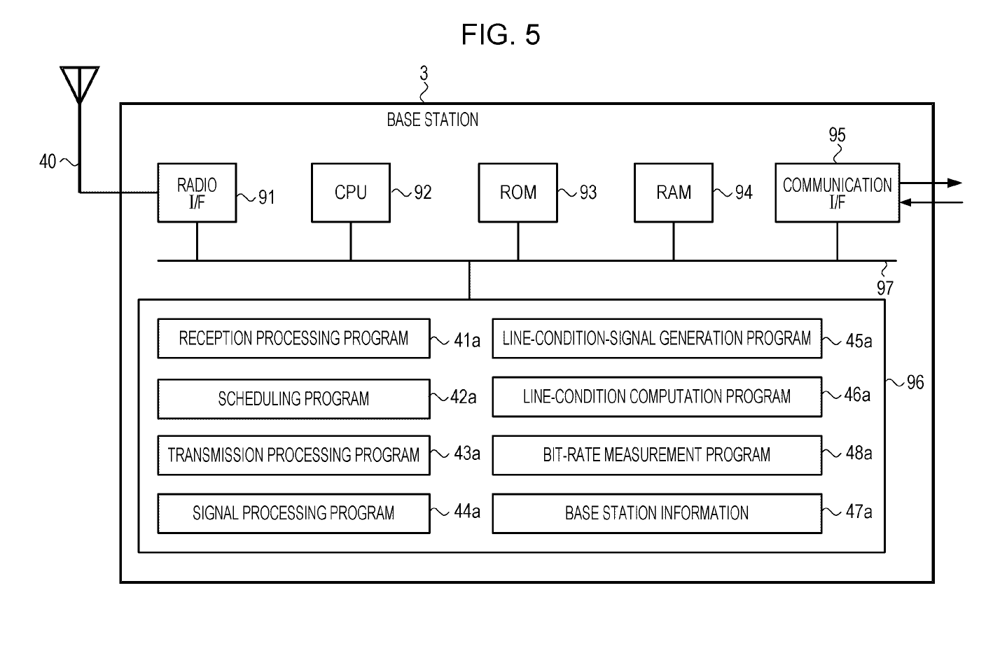

FIG. 5 is a hardware block diagram of the base station 3. The base station 3 includes the antenna 40, a radio I/F 91, a CPU 92, a ROM 93, a RAM 94, a communication I/F 95, and a storage unit 96. In FIG. 5, the same members as those in the functional block diagram of the base station 3 in FIG. 4 are designated with the same reference numerals, and are not described.

The CPU 92 is a computation unit that functions as each functional block illustrated in FIG. 4 by executing a program stored in the storage unit 96. The CPU 92 functions as the reception processing unit 41 by executing a reception processing program 41a stored in the storage unit 96. The CPU 92 functions as the scheduler 42 by executing a scheduling program 42a stored in the storage unit 96. The CPU 92 functions as the transmission processing unit 43 by executing a transmission processing program 43a stored in the storage unit 96. The CPU 92 functions as the signal processing unit 44 by executing a signal processing program 44a stored in the storage unit 96. The CPU 92 functions as the line-condition-signal generation unit 45 by executing a line-condition-signal generation program 45a stored in the storage unit 96. The CPU 92 functions as the line-condition computation unit 46 by executing a line-condition computation program 46a stored in the storage unit 96. The CPU 92 functions as the bit-rate measurement unit 48 by executing a bit-rate measurement program 48a stored in the storage unit 96.

The storage unit 96 stores the reception processing program 41a, the scheduling program 42a, the transmission processing program 43a, the signal processing program 44a, the line-condition-signal generation program 45a, the line-condition computation program 46a, the bit-rate measurement program 48a, and a base station information 47a. The storage unit 96 functions as the base-station-information storage unit 47 storing the base station information 47a.

The ROM 93 is nonvolatile memory such as flash memory. The RAM 94 is volatile memory such as DRAM. An internal bus 97 is used for data transmission between the devices implemented in the base station 3. The radio I/F 91 is implemented by, for example, an analog circuit or a DSP, and functions as the reception processing unit 41 and the transmission processing unit 43. The radio I/F 91 converts radio signals into bus signals and vice versa. The communication I/F 95 converts communication signals into bus signals and vice versa.

The hardware configuration described above allows the base station 3 to implement the functional blocks illustrated in FIG. 4.

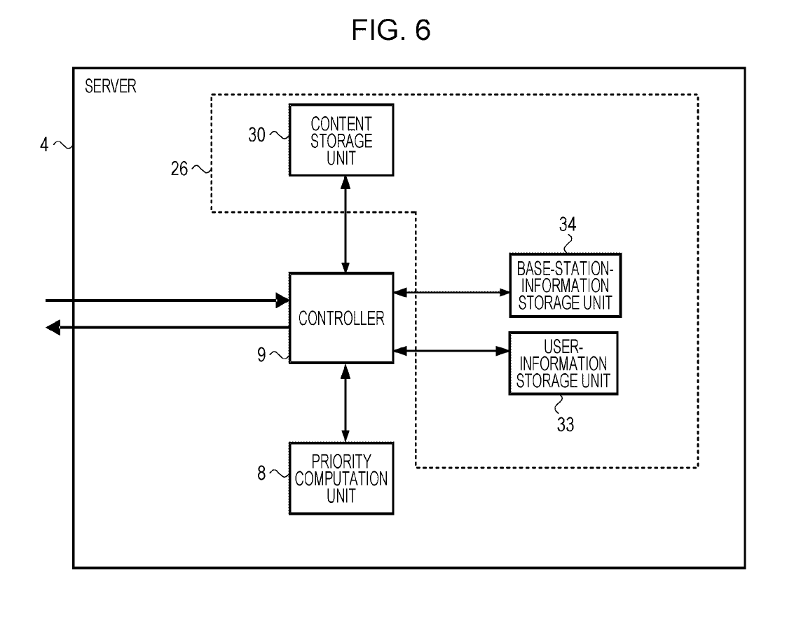

FIG. 6 is a functional block diagram of the server 4. The server 4 includes the storage unit 26, the controller 9, and the priority computation unit 8. The storage unit 26 further includes a content storage unit 30, a user-information storage unit 33, and a base-station-information storage unit 34.

The content storage unit 30 stores content to be transmitted to the mobile station 2. The controller 9 transmits a read-out request signal to the content storage unit 30 based on the priority information received from the priority computation unit 8.

The controller 9 writes distribution request information and viewing information for each of the mobile stations into the user-information storage unit 33 based on the distribution request signal and the signal indicating the viewing information, which are received from the mobile station. The controller 9 computes a viewing frequency for each piece of content based on the pieces of the viewing information written in the user-information storage unit 33. The controller 9 writes the computed viewing frequencies into the user-information storage unit 33.

The controller 9 transmits the content which is read out from the content storage unit 30 to the base station 3. The controller 9 writes user information into the user-information storage unit 33 based on the distribution request signal transmitted from the mobile station 2. For each mobile station the server 4 communicates with, the user-information storage unit 33 stores information about a base station through which communication is made, with an association between the base station and the mobile station. The controller 9 also writes the line-condition information transmitted from the base station 3 into the base-station-information storage unit 34.

The user-information storage unit 33 stores the user information written by the controller 9 so that the user information is associated with a corresponding mobile station. The base-station-information storage unit 34 stores the line-condition information written by the controller 9 so that the line-condition information is associated with a corresponding base station.

The priority computation unit 8 reads out list information of the content data from the content storage unit 30. The priority computation unit 8 reads out weighting coefficients based on user's desire for viewing and weighting coefficients corresponding to viewing frequencies for each piece of content from the user-information storage unit 33 via the controller 9. The priority computation unit 8 also reads out the line-condition information of the base station 3, which the mobile station 2 communicates with, from the base-station-information storage unit 34 via the controller 9.

The controller 9 causes the content storage unit 30 to transmit the content list in the content storage unit 30 to the priority computation unit 8 based on the distribution request signal received from the base station 3. The controller 9 causes the user-information storage unit 33 to transmit the user information in the user-information storage unit 33 to the priority computation unit 8 based on the distribution request signal. The controller 9 causes the base-station-information storage unit 34 to transmit the line-condition information in the base-station-information storage unit 34 to the priority computation unit 8 based on the distribution request signal.

The priority computation unit 8 computes a priority for the content that is to be transmitted to the mobile station 2 based on the content list, the user information, and the line-condition information which are transmitted from the storage unit 26. The priority computation unit 8 transmits to the controller 9 the priority information, which is the computation result.

As described above, the server 4 is capable of transmitting content having a high priority to the mobile station 2 with consideration of the communication condition of the base station 3 in response to the distribution request signal transmitted from the mobile station 2.

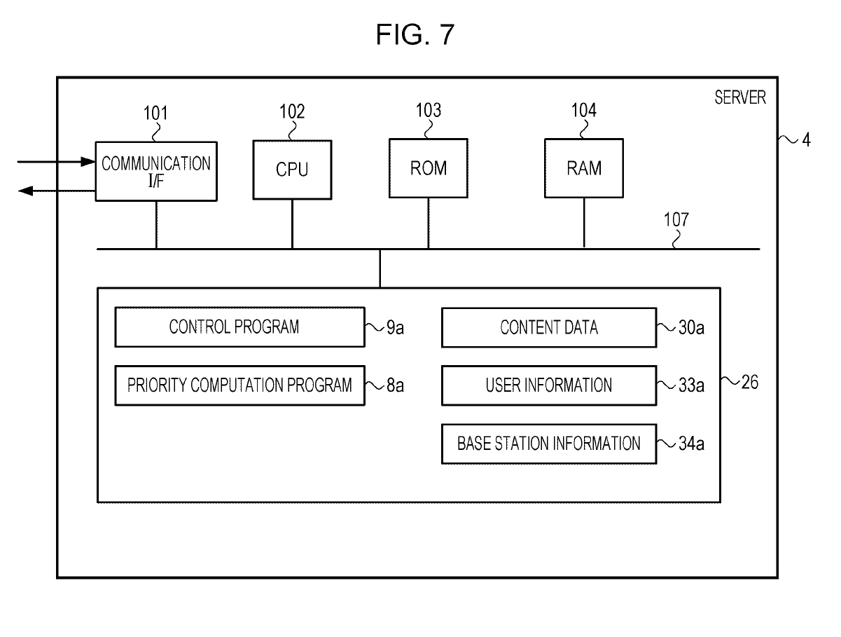

FIG. 7 is a hardware block diagram of the server 4. The server 4 includes a communication I/F 101, a CPU 102, a ROM 103, a RAM 104, and the storage unit 26. In FIG. 7, the same members as those in the functional block diagram of the server 4 in FIG. 6 are designated with the same reference numerals, and are not described.

The CPU 102 is a computation unit that functions as each functional block illustrated in FIG. 6 by executing a program stored in the storage unit 26. The CPU 102 functions as the controller 9 by executing a control program 9a stored in the storage unit 26. The CPU 102 functions as the priority computation unit 8 by executing a priority computation program 8a stored in the storage unit 26.

The storage unit 26 stores the control program 9a, the priority computation program 8a, content data 30a, user information 33a, and base station information 34a. The storage unit 26 functions as the content storage unit 30 storing the content data 30a, the user-information storage unit 33 storing the user information 33a, and the base-station-information storage unit 34 storing the base station information 34a.

The ROM 103 is nonvolatile memory such as flash memory. The RAM 104 is volatile memory such as DRAM. An internal bus 107 is used for data transmission between the devices implemented in the server 4. The communication I/F 101 converts communication signals into bus signals and vice versa.

The hardware configuration described above allows the server 4 to implement the functional blocks illustrated in FIG. 6.

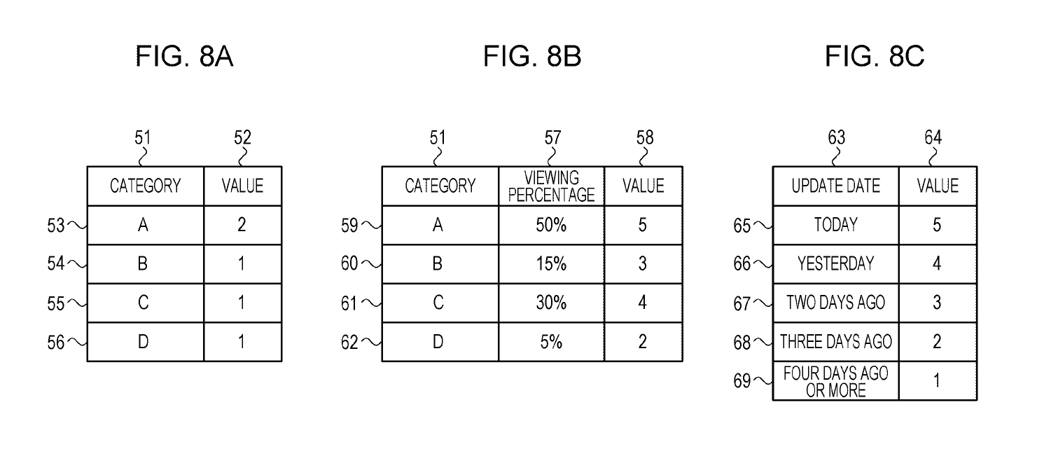

FIGS. 8A to 8C are tables illustrating weighting coefficients used to compute a priority for content to be transmitted from the server 4 to the mobile station 2. FIG. 8A is a table depicting weighting coefficients, which are associated with content categories and are set by a user of the mobile station 2. FIG. 8B is a table depicting weighting coefficients, which are associated with the respective content categories and are set based on a history of actual viewing by the user of the mobile station 2. FIG. 8C is a table depicting weighting coefficients which are set in accordance with the update time of content.

In FIG. 8A, a column 51 depicts the content categories. A column 52 depicts weighting coefficients assigned to the categories. A row 53 indicates that a weighting coefficient ‘2’ is assigned to a category A. Rows 54 to 56 indicate that a weighting coefficient ‘1’ is assigned to categories B to D, respectively.

A user inputs a category from which the user wants to obtain content with high priority from among a plurality of content categories, via the terminal operation unit 73. According to the embodiment, the user selects a category A. The controller 5 assigns a weighting coefficient of ‘2’ to the selected category A, and a weighting coefficient of ‘1’ to the other categories. The controller 5 transmits a weighting coefficient assigned to each category as illustrated in FIG. 8A to the signal generation unit 75. The signal generation unit 75 generates a distribution request signal based on the received weighting coefficient for each category. The signal generation unit 75 transmits the generated distribution request signal to the server 4. The user-information storage unit 33 of the server 4 stores the weighting coefficients based on the distribution request signal.

In FIG. 8B, a column 51 is the same as that in FIG. 8A. A column 57 depicts viewing percentages which are computation results based on a history of actually viewing content in each category by a user. A column 58 depicts weighting coefficients which are set based on the viewing percentages.

A row 59 indicates that the viewing percentage for the category A is 50% and that the weighting coefficient for the category A is ‘5’. A row 60 indicates that the viewing percentage for the category B is 15% and that the weighting coefficient for the category B is ‘3’. A row 61 indicates that the viewing percentage for the category C is 30% and that the weighting coefficient for the category C is ‘4’. A row 62 indicates that the viewing percentage for the category D is 5% and that the weighting coefficient for the category D is ‘2’. According to the embodiment, weighting coefficients ‘5’ to ‘2’ are assigned in decreasing order of the viewing percentage.

The viewing information for content which is received from the mobile station 2 is stored in the user-information storage unit 33 of the server 4. The controller 9 computes a viewing percentage for each category based on the viewing information stored in the user-information storage unit 33. The controller 9 sets a weighting coefficient for each category based on the computed viewing percentages as in the table illustrated in FIG. 8B. The user-information storage unit 33 stores the weighting coefficients which are set by the controller 9.

In FIG. 8C, a column 63 represents update date and time of content. A column 64 represents weighting coefficients assigned in chronological order based on the update date. A row 65 indicates that a weighting coefficient of ‘5’ is assigned to content whose update date is today. A row 66 indicates that a weighting coefficient of ‘4’ is assigned to content whose update date is yesterday. A row 67 indicates that a weighting coefficient of ‘3’ is assigned to content whose update date is two days ago. A row 68 indicates that a weighting coefficient of ‘2’ is assigned to content whose update date is three days ago. A row 69 indicates that a weighting coefficient of ‘1’ is assigned to content whose update date is four days ago or more.

The weighting coefficients in the table illustrated in FIG. 8C are stored in advance in the priority computation unit 8 of the server 4, regardless of a distribution request signal transmitted from the mobile station 2. The priority computation unit 8 also assigns a weighting coefficient of ‘2’ to content which a user is currently viewing, and a weighting coefficient of ‘1’ to other content.

The priority computation unit 8 calculates weighting for each piece of content based on the weighting coefficients for the respective content categories that are read out from the storage unit 26 and the weighting coefficients that are stored in the priority computation unit 8 as described above.

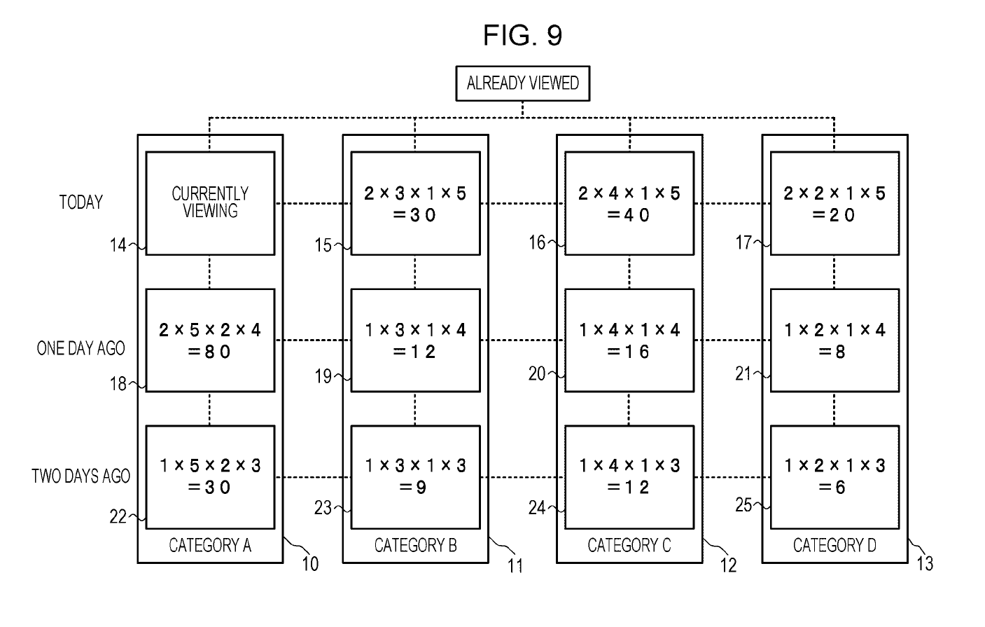

FIG. 9 is a block diagram illustrating how pieces of content are linked to each other and priorities for each piece of content. Blocks 10, 11, 12, and 13 are blocks of content grouped in accordance with the categories A, B, C, and D, respectively. Each block contains pieces of content classified in accordance with their viewing date. Blocks 14, 18, and 22 indicate pieces of content in the category A corresponding to today, one day ago, and two days ago, respectively. Blocks 15, 19, and 23 indicate pieces of content in the category B corresponding to today, one day ago, and two days ago, respectively. Blocks 16, 20, and 24 indicate pieces of content in the category C corresponding to today, one day ago, and two days ago, respectively. Blocks 17, 21, and 25 indicate pieces of content in the category D corresponding to today, one day ago, and two days ago, respectively.

The link relationship between pieces of content is fixed. The content storage unit 30 of the server 4 stores link information indicating the link relationship between pieces of content. The controller 9 determines weighting coefficients for each piece of content based on the viewing information received from the mobile station 2 and the link information. According to the embodiment, the controller 9 assigns a weighting coefficient ‘2’ to pieces of content corresponding to the same day as the currently viewed content and to pieces of content in the same category as that of the currently viewed content and corresponding to one day before or after the date of the currently viewed content, and assigns a weighting coefficient ‘1’ to the other pieces of content. For example, when the piece of content corresponding to the block 14 is currently viewed, the weighting coefficients based on the link information for the blocks 15, 16, 17, and 18 are set to ‘2’, and the weighting coefficients based on the link information for the other pieces of content are set to ‘1’.

In an equation illustrated in each of the blocks, the first term represents a weighting coefficient based on the link information. The second term represents a weighting coefficient based on the viewing percentage that is associated with a corresponding category. The third term represents a weighting coefficient based on the user's desire for viewing. The fourth term represents a weighting coefficient based on the update date of the content.

The computation procedure using the weighting coefficients will be described taking the block 18 as an example. The first weighting coefficient in the block 18 is set to ‘2’ based on the link relationship between the block 18 and the block 14 that has a piece of content that is currently viewed. The second weighting coefficient is set to ‘5’ based on the table illustrated in FIG. 8B. The third weighting coefficient is set to ‘2’ based on the table illustrated in FIG. 8A. The fourth weighting coefficient is set to ‘4’ based on the table illustrated in FIG. 8C. As described above, the computation result obtained from the weighting coefficients for the block 18 is ‘2×5×2×4=80’.

Priorities for the other blocks are computed based on the weighting coefficients. Priorities for the blocks may be determined by sorting the blocks in descending order of computation result.

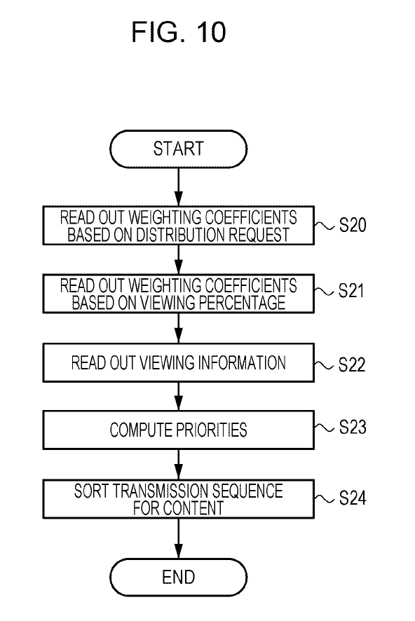

FIG. 10 is a flowchart of a priority computation process performed by the priority computation unit 8. In step S20, the priority computation unit 8 reads out weighting coefficients based on the distribution request from a user, which are illustrated in FIG. 8A, from the user-information storage unit 33. In step S21, the priority computation unit 8 reads out weighting coefficients based on the viewing percentage, which are illustrated in FIG. 8B, from the user-information storage unit 33. In step S22, the priority computation unit 8 reads out the viewing information indicating which piece of content the user is currently viewing, from the user-information storage unit 33.

In step S23, the priority computation unit 8 computes a priority for each piece of content based on the following read out information: the distribution request information, the viewing percentage information, and the current viewing information. In step S24, the priority computation unit 8 sorts a transmission sequence for the pieces of content to be transmitted to the mobile station 2 based on the computation result for priority.

As described above, the priority computation unit 8 of the server 4 is capable of computing priorities for the pieces of content to be transmitted to the mobile station 2 based on the distribution request from the user and the actual viewing percentage.

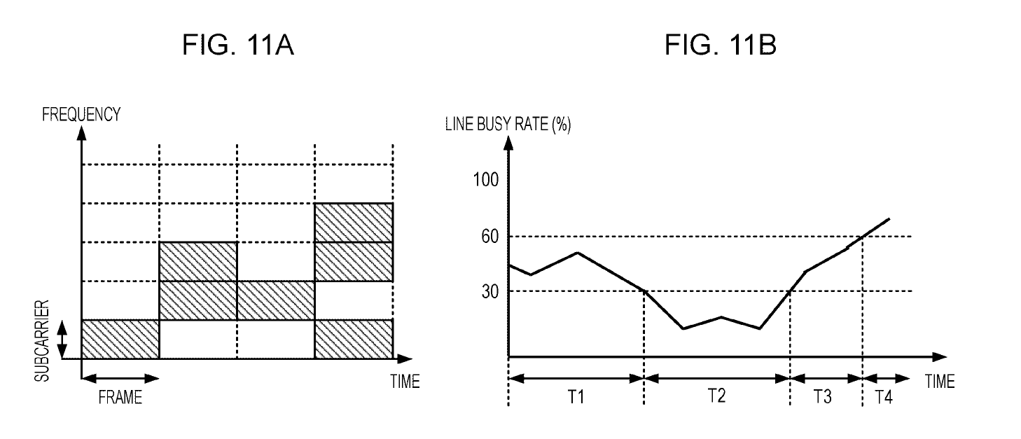

FIGS. 11A and 11B are image diagrams illustrating line-condition information transmitted from the base station 3 to the server 4. FIG. 11A illustrates a change in usage of communication resources with time. FIG. 11B illustrates a relationship between the line condition computed from the usage of the communication resources and thresholds that are set in the server 4.

In FIG. 11A, the horizontal axis represents time, and the vertical axis represents frequency. The time axis is separated into frames. The frequency axis is separated into subcarriers. A diagonally shaded rectangle in the graph indicates that a frame during the corresponding time period occupies the corresponding subcarrier. The graph illustrated in FIG. 11A is generated based on the communication schedule information between the base station 3 and each mobile station. The change in the line condition for each frame may be computed by checking an occupation rate for the frame, that is, how many subcarriers are occupied among all of the subcarriers assigned to the base station 3.

In FIG. 11B, the horizontal axis represents time, and the vertical axis represents a line busy rate which is one of the indexes for line condition. The server 4 sets, for example, 60% to a threshold for the line busy rate which is used if the base station 3 is capable of transmitting small-size content data. The server 4 sets, for example, 30% to a threshold for the line busy rate which is used if the base station 3 is capable of transmitting large-size content data. The controller 9 of the server 4 compares the line-condition information received from the base station 3 with these thresholds, and determines whether or not the content data is to be distributed. The thresholds used for determining a line busy rate are set with consideration of the data size of content and the communication resources of the base station 3. The controller 9 sets in advance regarding capability of handling large-size and small-size content data.

In a time period T1, the line busy rate for the base station 3 is more than 30% and equal to or less than 60%. The controller 9 transmits content data to the base station 3 based on the computation result from the priority computation unit 8. When large-size content data is to be transmitted, the controller 9 gives a lower priority to the large-size content data, and transmits small-size content data first.

In a time period T2, the line busy rate for the base station 3 is equal to or less than 30%. The controller 9 first transmits the large-size content data that had been given a lower priority to the base station 3, and after that, transmits content data in accordance with the computation result for priority.

In a time period T3, the line busy rate for the base station 3 becomes more than 30% and equal to or less than 60% again. The controller 9 transmits content data to the base station 3 based on the computation result from the priority computation unit 8. If large-size content data is to be transmitted, the controller 9 gives a lower priority to the large-size content data, and transmits small-size content data first.

In a time period T4, the line busy rate for the base station 3 is more than 60%. When the line busy rate is more than 60%, the communication resources of the base station 3 are insufficient even for small-size content. Accordingly, the base station 3 fails to transmit content to mobile stations. In this case, the controller 9 stops transmission of content data to the base station 3.

As described above, a transmission sequence of content data that is to be transmitted from the server 4 to the mobile station 2 is changed in accordance with the line condition of the base station 3, achieving data distribution in which the line condition of the base station 3 and priorities for content data are taken into account. When the line busy rate exceeds a certain value, transmission of content data is stopped, resulting in reduction in unnecessary consumption of communication resources.

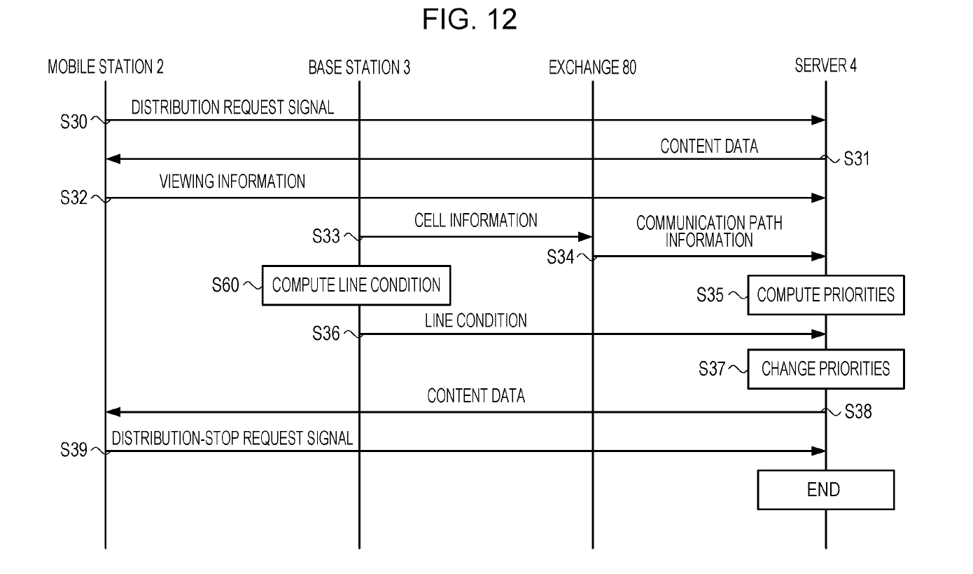

FIG. 12 is a sequence diagram illustrating the entire process of the data distribution system 1. In step S30, the mobile station 2 transmits a distribution request signal to the server 4 via the base station 3 and the exchange 80. In step S31, the server 4 transmits the requested content data to the mobile station 2 via the exchange 80 and the base station 3.

The received content data is viewed at the mobile station 2. In step S32, the mobile station 2 transmits viewing information indicating information about the viewed content to the server 4. In step S33, the base station 3 transmits cell information indicating that the mobile station 2 belongs to the cell area of the base station 3 to the exchange 80. In step S34, the exchange 80 transmits communication path information between each base station and the mobile station 2 to the server 4.

In step S35, the server 4 computes the priorities based on the distribution request signal and the viewing information, which are received from the mobile station 2, and the communication path information, which is received from the exchange 80. The server 4 sorts the transmission sequence for content data in accordance with the computed priorities.

In step S60, the base station 3 computes the line condition based on the communication schedule between the base station 3 and the mobile stations that are present in the cell area of the base station 3. In step S36, the base station 3 transmits the computation result for the line condition to the server 4 as the line-condition information.

The server 4 refers to the line-condition information of the base station 3 before transmitting content data in accordance with the computed priorities. In step S37, the server 4 changes the priorities for the content data to be transmitted to the base station 3 based on the line-condition information.

In step S38, the server 4 transmits the content data to the mobile station 2 in accordance with the changed priorities. The server 4 repeatedly performs the above process and continues to distribute content data to the mobile station 2 at certain time intervals.

When the mobile station 2 intends to stop reception of content data, the mobile station 2 transmits a distribution-stop request signal to the server 4 in step S39. When the server 4 receives the distribution-stop request signal from the mobile station 2, the server 4 stops transmission of content data to the mobile station 2.

As described above, content data is distributed from the server 4 to the mobile station 2 based on the distribution request and the viewing information from the mobile station 2 and the line-condition information from the base station 3, allowing the data distribution system 1 to distribute content data so that the priorities for distribution and the line condition of the base station 3 are taken into account.

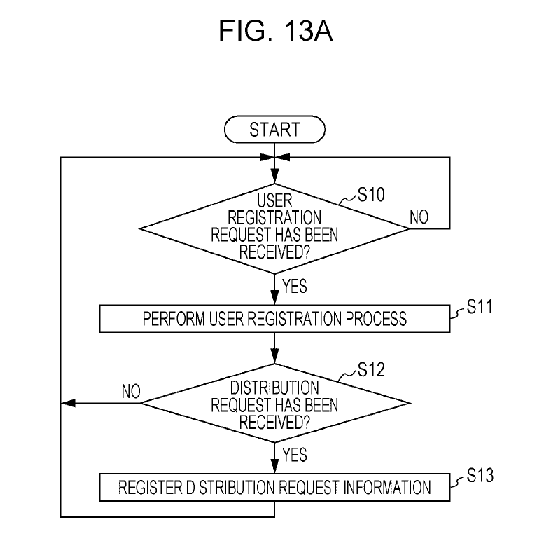

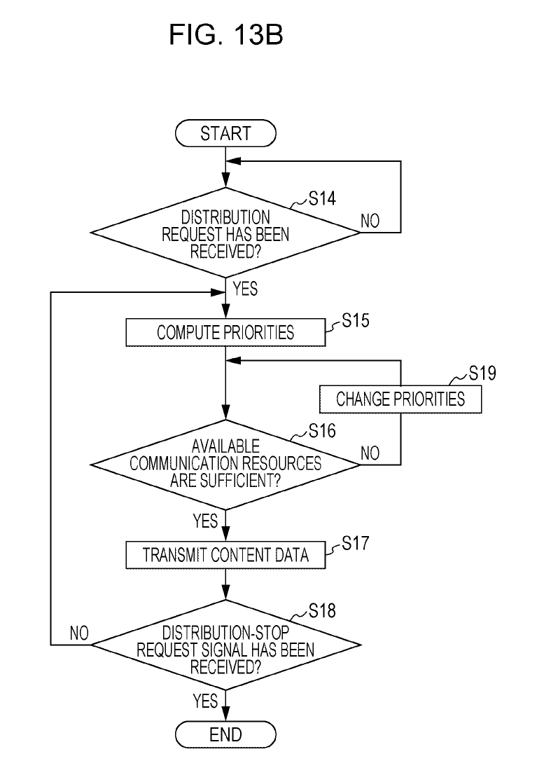

FIGS. 13A and 13B are flowcharts of processes performed by the server 4. FIG. 13A illustrates a process of registering a distribution request from the user for the mobile station 2, which is performed by the server 4. FIG. 13B illustrates a process of distributing content data that is performed by the server 4.

In FIG. 13A, when the server 4 has received a request for user registration from the mobile station 2 (YES in step S10), the server 4 performs a user registration process in step S11. As part of the user registration, when the server 4 has received a distribution request for content data (YES in step S12), the server 4 registers the distribution request information with an association between the user and the distribution request information in step S13.

In FIG. 13B, when the server 4 has received a distribution request for content data from the mobile station 2 (YES in step S14), the server 4 computes priorities for content data in step S15. After the mobile station 2 transmits a distribution-start request signal for content data to the server 4, the mobile station 2 transmits viewing information of the content to the server 4 at a certain regular time interval.

The server 4 receives line-condition information from the base station 3. When the server 4 determines that the base station 3 has available communication resources which are sufficient for the size of the content data to be transmitted, based on the received line-condition information (YES in step S16), the server 4 transmits the content data to the mobile station 2 in step S17. Otherwise, when the server 4 determines that the base station 3 has communication resources which are insufficient for the size of the content data to be transmitted (NO in step S16), the server 4 changes the priorities for content data so that the priorities for pieces of small-size content data are set to high among the pieces of content data to be transmitted to the mobile station 2, in step S19. The server 4 checks again if the base station 3 has available communication resources which are sufficient for the size of the content data to be transmitted, based on the changed priorities in step S16.

When the server 4 has received a distribution-stop request signal from the mobile station 2 (YES in step S18), the server 4 stops the distribution of content data to the mobile station 2.

As described above, the server 4 is capable of distributing content data to the mobile station 2 based on the distribution request and the viewing information from the mobile station 2 and the line-condition information from the base station 3.

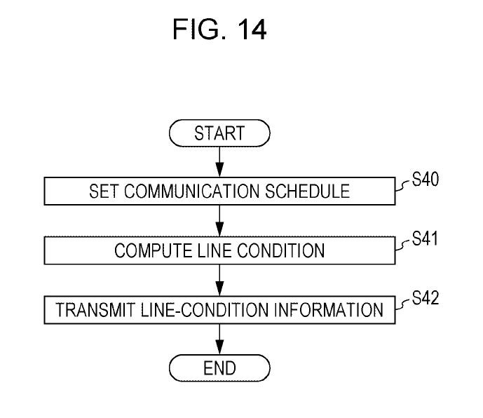

FIG. 14 is a flowchart of a line-condition computation process performed by the base station 3. In step S40, the base station 3 sets a communication schedule between the base station 3 and mobile stations based on a reception schedule for receiving data from the mobile stations and a transmission schedule for transmitting data to the mobile stations.

In step S41, the base station 3 computes the line condition between the base station 3 and the mobile stations based on the communication schedule which has been set. In step S42, the base station 3 transmits the computed line-condition information to the server 4.

As described above, the base station 3 is capable of transmitting the line-condition information to the server 4 based on the communication schedule between the base station 3 and the mobile stations.

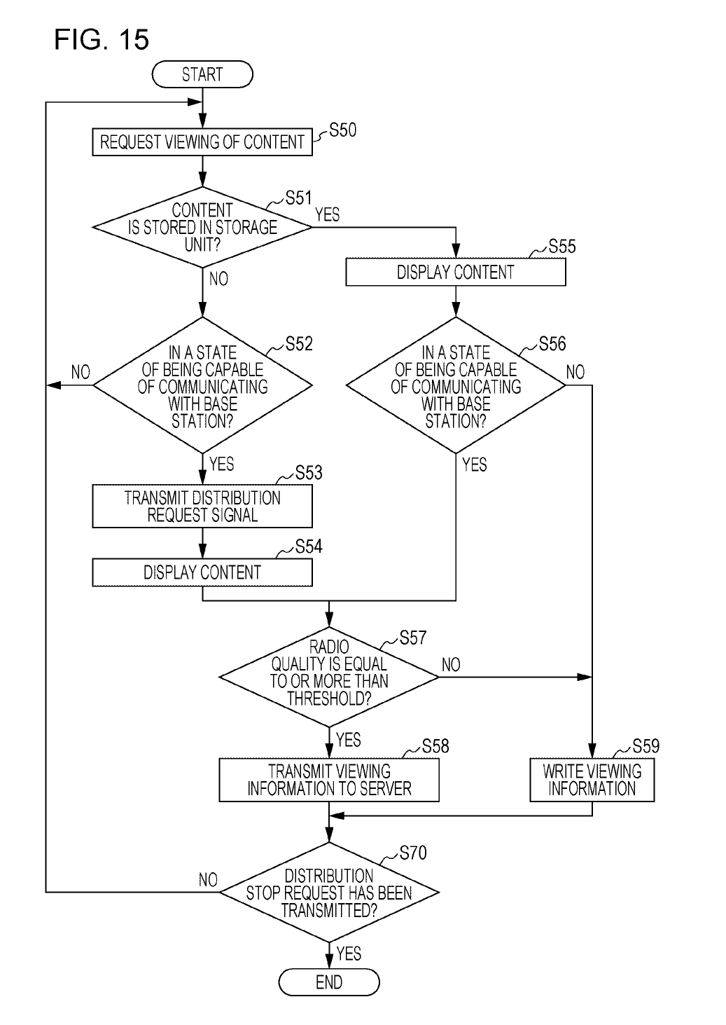

FIG. 15 is a flowchart of a content-data viewing process performed by the mobile station 2. In step S50, the user for the mobile station 2 specifies content to be requested for viewing, from the terminal operation unit 73. When the content specified by the user exists in the content storage unit 6 of the mobile station 2 (YES in step S51), the mobile station 2 displays the specified content on the display unit 71 in step S55.

When the content specified by the user does not exist in the content storage unit 6 of the mobile station 2 (NO in step S51), the mobile station 2 tries to communicate with the base station 3. When the mobile station 2 is capable of communicating with the base station 3 (YES in step S52), the mobile station 2 transmits to the server 4 a distribution request signal for content in step S53. When the content data is distributed in response to the distribution request for the content, the mobile station 2 displays the distributed content on the display unit 71. Otherwise, when the mobile station 2 is incapable of communicating with the base station 3 (NO in step S52), the mobile station 2 returns back to the content specification process, that is, to step S50. The mobile station 2 may request the user to specify other content.

After the content is displayed in step S55, the mobile station 2 tries to communicate with the base station 3 in step S56. When the mobile station 2 is capable of communicating with the base station 3 (YES in step S56), the mobile station 2 checks the radio quality between the mobile station 2 and the base station 3. In step S57, the mobile station 2 compares the current radio quality to a threshold that is preset for determining radio quality. If the current radio quality is greater than or equal to the threshold (YES in step S57), the mobile station 2 transmits viewing information to the server 4 in step S58. If the current radio quality is less than the threshold (NO in step S57), the mobile station 2 writes the viewing information in the viewing-information storage unit 74 of the mobile station 2 in step S59. The viewing information written in the viewing-information storage unit 74 is transmitted again to the base station 3 after a certain time period.

When the mobile station 2 has transmitted to the server 4 a distribution stop request for stopping the distribution of content data (YES in step S70), the mobile station 2 ends the content-data viewing process. While the mobile station 2 has transmitted no distribution stop request (NO in step S70), the mobile station 2 continues the content-data viewing process starting from step S50.

As described above, the mobile station 2 is capable of causing content data received from the server 4 to be viewed and also of transmitting viewing information to the server 4.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data distribution system comprising:
a mobile station;
a base station; and
a server that distributes data to the mobile station via the base station,
wherein the base station transmits information about a line condition between the base station and the mobile station to the server, and
wherein the server distributes data to the base station based on the information about the line condition.

2. The data distribution system according to claim 1, wherein
the base station includes
a scheduler that manages a schedule for distributing a signal to the mobile station, and
a line-condition computation unit that computes the line condition between the base station and the mobile station based on information of the schedule and a distribution capacity of the base station.

3. The data distribution system according to claim 1, wherein
the server includes
a priority computation unit that computes priorities for each piece of content to be transmitted to the mobile station, based on a distribution request signal for content that is received from the mobile station, and
a controller that controls timing of distributing data to the base station in accordance with the computed priorities, based on the information about the line condition that is received from the base station.

4. A server that distributes data to a mobile station via a base station, the server comprising:
a priority computation unit that computes priorities for each piece of content to be transmitted to the mobile station, based on a distribution request signal for content that is received from the mobile station; and
a controller that controls timing of distributing data to the base station in accordance with the computed priorities, based on information about a line condition between the mobile station and the base station that is received from the base station.

5. A base station that distributes data received from a server to a mobile station, the base station comprising:
a scheduler that manages a schedule for distributing a signal to the mobile station; and
a line-condition computation unit that computes a line condition between the base station and the mobile station based on information of the schedule and a distribution capacity of the base station.

6. A method of controlling a data distribution system that includes a server to distribute content data, a base station to transmit the content data received from the server, and a mobile station to receive the content data transmitted from the base station, the method comprising:
transmitting, using the mobile station, a distribution request signal for requesting transmission of the content data to the server;
transmitting, using the base station, the distribution request signal received from the mobile station and information about a line condition between the base station and the mobile station to the server; and
distributing, using the server, the content data to the base station based on the distribution request signal and the information about the line condition.
